(19) United States
(12) Patent Application Publication
(10) Pub. No.: US 2006/0076487 A1
(43) Pub. Date: Apr. 13, 2006

(54) Semiconductor probe, method of manufacturing the same, and method and apparatus for analyzing semiconductor surface using semiconductor probe

(75) Inventors: Ju-hwan Jung, Seoul (KR); Sung-dong Kim, Seongnami-si (KR); Seung-bum Hong, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/199,116

(22) Filed: Aug. 9, 2005

Related U.S. Application Data
(60) Provisional application No. 60/616,623, filed on Oct. 8, 2004.

(51) Int. Cl. G01N 23/00

(52) U.S. Cl. 250/306

(57) ABSTRACT

Provided are a semiconductor probe, a method of manufacturing the same, and an apparatus and method for analyzing a semiconductor surface using the semiconductor probe. The semiconductor probe includes a semiconductor tip containing a low concentration of impurities and a cantilever having a conductive area formed in close proximity to the semiconductor tip attached at one end thereof and doped with a high concentration of impurities. The analysis apparatus and method uses high resolution, non-destructive measurement by forming a PN junction between the sample and the semiconductor probe, thereby enabling quantitative extraction of impurity concentration of the sample.

### CROSS-REFERENCE TO RELATED PATENT APPLICATION

This application claims the benefit of U.S. Provisional Patent Application No. 60/616,623, filed on Oct. 8, 2004, in the U.S. Patent and Trademark Office, the disclosure of which is incorporated herein in its entirety by reference.

### BACKGROUND OF THE INVENTION

1. Field of the Invention

The present invention relates to a semiconductor probe, a method of manufacturing the same, and a method and apparatus for analyzing a semiconductor surface using the semiconductor probe, and more particularly, to a semiconductor probe forming a PN junction with a semiconductor surface, a method of manufacturing the same, and a method and apparatus for analyzing a semiconductor surface using the semiconductor probe.

2. Description of the Related Art

Semiconductor devices such as DRAM, FLASH, and FRAM are manufactured by integrating transistors acting as a resistor, a capacitor, an amplifier, or a switch onto a semiconductor substrate in the desired arrangement. In particular, a source-gate-drain structure in an NPN or PNP metal-oxide-silicon field effect transistor (MOSFET) is formed by implanting impurities such as boron (B), phosphorous (P), and arsenic (As) into predetermined regions on the surface of a semiconductor substrate using ion implantation. The spatial distribution of concentration of impurities in P- and N-type impurity implantation regions is an important design parameter in the fabrication of a semiconductor device.

Thus, the measurement of concentration of impurities is essential for the design of a semiconductor device. An analysis technique, such as Secondary Ion Mass Spectroscopy (SIMS), Chemical Etching Decoration (CED), Scanning Spreading Resistance Microscopy (SSRM), or Scanning Capacitance Microscopy (SCM) is being currently developed to measure the concentration of impurities.

A two-dimensional display mode called ‘mapping’ has recently been added to SIMS that is a destructive surface analysis to perform two-dimensional measurement. However, since a condensing diameter of ions is typically of the order of micrometers, this technique cannot provide a resolution sufficient for the measurement of a source-drain region.

SCM, one of the scanning probe microscopy (SPM) techniques, provides superior horizontal resolution over SIMS but has difficulty in obtaining information in the direction of depth. Another drawback of the SCM is that implanted impurities are difficult to quantify since it measures the spatial variation of capacitance.

To compensate for the above drawbacks of SIMS and SCM analyses, U.S. Pat. No. 6,121,060 proposes a method of measuring a concentration profile including etching a semiconductor substrate using an etchant with an etching rate that varies depending on the concentration of impurities and measuring the concentration profile of impurities using an etched shape. However, as a destructive surface analysis like the SIMS technique, this approach is technically complicated to perform since it indirectly extracts the concentration of impurities.

SSRM, which is a combination of Spreading Resistance Profiler (SRP) and SPM, measures the amount of current flowing from a conductive probe into a sample after applying a predetermined voltage between the sample and the conductive probe in contact with the sample in order to extract the variation of impurity concentration in the sample. However, this technique shows almost no difference between concentrations since the variation of impurity concentration is caused due to resistance that varies depending on the amount of impurities contained in the sample.

### SUMMARY OF THE INVENTION

The present invention provides a semiconductor probe designed to measure the concentration of impurities with a high resolution, a method of manufacturing the same, and a method and apparatus for analyzing a semiconductor surface using the semiconductor probe.

According to an aspect of the present invention, there is provided a semiconductor probe including: a semiconductor tip containing a low concentration of impurities; and a cantilever having a conductive area formed in close proximity to the semiconductor tip attached at one end thereof and doped with a high concentration of impurities.

An electrode may be formed on the cantilever to conduct an electric current between the conductive area and an external power supply. The semiconductor tip may have an impurity concentration of 10¹⁵/cm³ to 10²⁰/cm³. The impurities may be, for example, arsenic (As), phosphorous (P), or boron (B). The semiconductor tip may be made of, for example, silicon (Si), gallium arsenide (GaAs), diamond-like carbon (DLC), or silicon carbide (SiC).

According to another aspect of the present invention, there is provided a method of manufacturing a semiconductor probe including: forming a hard mask layer on a substrate doped at a low concentration; patterning the hard mask layer into a predetermined shape at a region where a semiconductor tip will be formed; etching the substrate underlying the hard mask layer and forming the semiconductor tip; doping a portion of the substrate not blocked by the hard mask layer with high concentration impurities and forming a conductive area; and removing the hard mask pattern and sharpening the semiconductor tip.

Alternatively, the method may include: depositing a semiconductor tip layer doped with impurities at a low concentration on a substrate and forming a hard mask layer on the semiconductor tip layer; patterning the hard mask layer into a predetermined shape at a region where a semiconductor tip will be formed; etching the semiconductor tip layer underlying the hard mask layer and forming the semiconductor tip; doping a portion of the substrate not blocked by the hard mask layer with high concentration impurities and forming a conductive area; and removing the hard mask pattern and sharpening the semiconductor tip.

The semiconductor tip may have an impurity concentration of 10¹⁵/cm³ to 10²⁰/cm³. The impurities may be, for example, As, P, or B. The semiconductor tip layer may be made of, for example, Si, GaAs, DLC, or SiC. The hard mask layer may be an oxide layer formed by thermal oxidation.

According to another aspect of the present invention, there is provided an apparatus for analyzing a surface of a semiconductor sample, including: a semiconductor probe including a tip containing a low concentration of impurities and a cantilever with a conductive area doped with a high concentration of impurities, the semiconductor probe contacting and forming a PN junction with the surface of the semiconductor sample; a scanner moving the semiconductor probe with respect to the surface of the semiconductor sample; and a controller outputting a signal driving the scanner detecting an impurity concentration in a region on the surface of the semiconductor sample that contacts the semiconductor probe by measuring current flowing into the semiconductor sample after application to the semiconductor probe.

The sample may be, for example, Si, GaAs, or SiC. The semiconductor tip may have an impurity concentration of 10¹⁵/cm³ to 10²⁰/cm³, and be made of, for example, Si, GaAs, DLC, or SiC. The impurities may be, for example, As, P, or B.

According to another aspect of the present invention, there is provided a method for analyzing a surface of a semiconductor sample using the semiconductor sample and a semiconductor probe in contact with the semiconductor sample, the method including: forming a PN junction between the semiconductor sample and the semiconductor probe having a tip having opposite polarity to the semiconductor sample; and detecting impurity concentration of the semiconductor sample from variation in current flowing through the semiconductor probe.

The sample may be, for example, Si, GaAs, DLC, or SiC. The semi-conductor probe includes a cantilever having a conductive area doped with high concentration impurities and a semiconductor tip attached at one end of the cantilever. The semiconductor tip may have an impurity concentration of 10¹⁵/cm³ to 10²⁰/cm³, and be made of, for example, Si, GaAs, DLC, or SiC. The impurities may be, for example, As, P, or B.

The present invention uses the apparatus for analyzing a semiconductor surface with a probe having a semiconductor tip designed to extract impurity concentration by measuring the amount of current across a PN junction between the probe and a sample to allow high resolution analysis of the semiconductor surface. The method for analyzing a semiconductor surface is a kind of nondestructive analysis and is highly sensitive to concentrations because it uses current-voltage (IV) characteristics of the PN junction between the sample and the probe. The method also allows ease of measurement and reliable measurement due to a small resistance between the probe and an external voltage applying unit.

### BRIEF DESCRIPTION OF THE DRAWINGS

The above and other features and advantages of the present invention will become more apparent by describing in detail exemplary embodiments thereof with reference to the attached drawings in which:

FIG. 1 briefly shows the structure of a semiconductor probe according to an embodiment of the present invention;

FIGS. 2A-2H illustrate steps of a method of manufacturing a semiconductor probe according to a first embodiment of the present invention;

FIGS. 3A-3F illustrate steps of a method of manufacturing a semiconductor probe according to a second embodiment of the present invention;

FIGS. 4A-4E illustrates steps of a method of manufacturing a semiconductor probe according to a third embodiment of the present invention;

FIG. 5 is a schematic diagram of an apparatus for analyzing a semiconductor surface using a semiconductor probe according to an embodiment of the present invention; and

FIG. 6 is a graph illustrating current-voltage (IV) characteristics measured on semiconductor samples with different impurity concentrations using an apparatus for analyzing a semiconductor surface according to an embodiment of the present invention.

### DETAILED DESCRIPTION OF EXEMPLARY EMBODIMENTS OF THE INVENTION

A semiconductor probe, a method of manufacturing the same, and an apparatus and method for analyzing a semiconductor surface using the semiconductor probe according to embodiments of the present invention will be described in detail with reference to the accompanying drawings.

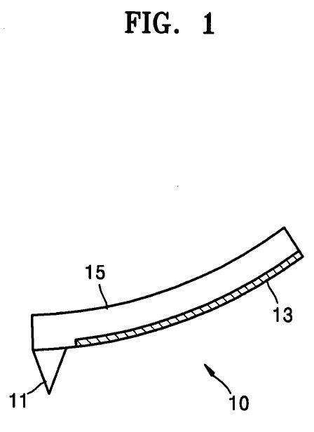

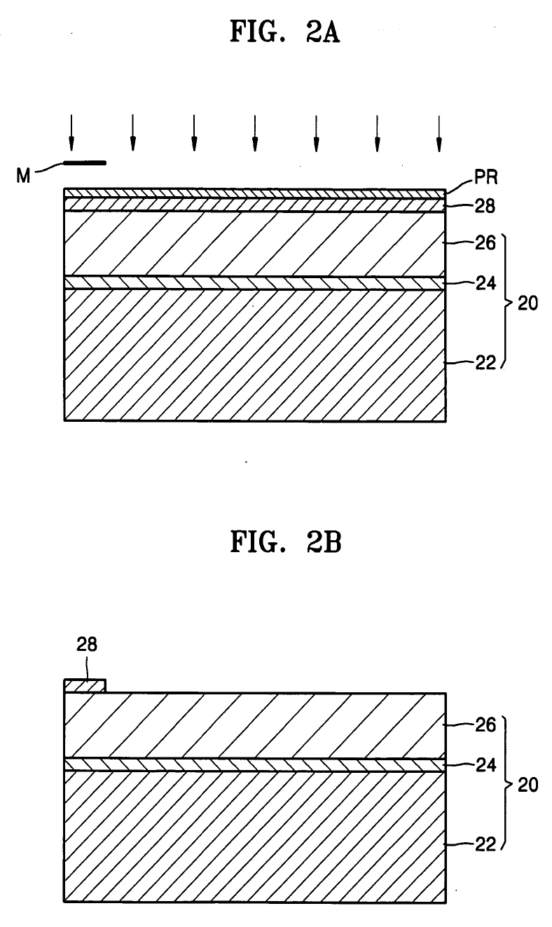

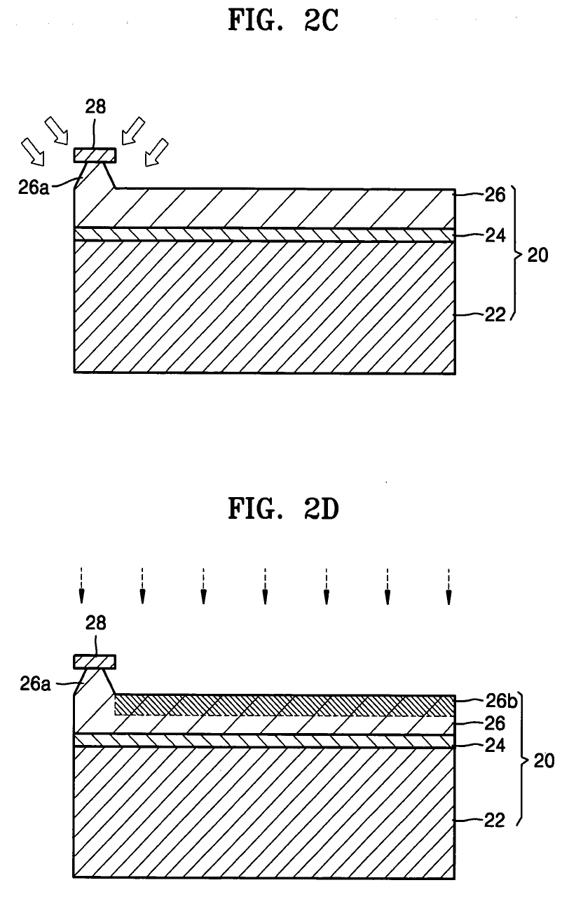

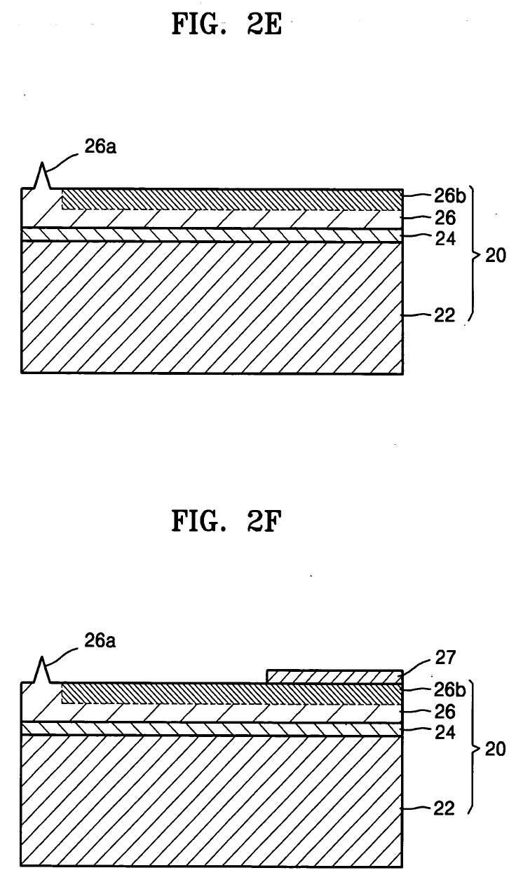

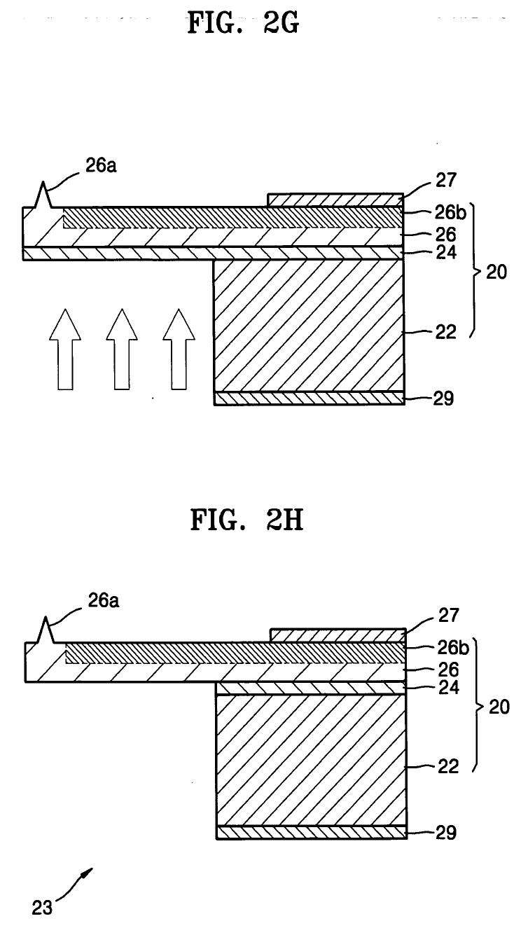

First, the semiconductor probe and the method of manufacturing the same according to embodiments of the present invention will now be described with reference to FIGS. 1-2H.

FIG. 1 is a cross-sectional view of a semiconductor probe 10 according to an embodiment of the present invention. Referring to FIG. 1, the semiconductor probe 10 includes a cantilever 15 on which a conductive area 13 doped with a high concentration of impurities is formed and a tip 11 that is attached at the distal end of the cantilever 15 and contains a low concentration of impurities. The tip 11 and the cantilever 15 are made of monocrystalline silicon, or gallium arsenide (GaAs), or silicon carbide. The tip 11 is doped with impurities such as arsenic (As), phosphorous (P), or boron (B). When a sample to be measured is an N-type semiconductor, the tip 11 is doped with P-type impurities. When the sample is a P-type semiconductor, the tip 11 is doped with N-type impurities.

FIGS. 2A-2H illustrate steps of a method of manufacturing a semiconductor probe according to a first embodiment of the present invention. Referring to FIG. 2A, first, a semiconductor substrate 20 containing a low concentration of impurities is prepared, and a hard mask layer 28 is formed on the semiconductor substrate 20 using silicon dioxide (SiO₂) deposited by thermal growth. The substrate 20 may be a silicon-on-insulator (SOI) substrate consisting of a stack of a first silicon layer 22, an oxide layer 24, and a second silicon layer 26.

Subsequently, a photoresist layer PR is formed on the hard mask layer 28, and a circular or square-shaped mask M is placed above a portion of the photoresist layer PR where a tip will be formed, which is then irradiated with and exposed to ultraviolet (UV) light.

After exposure, a photo process including developing and etching is performed on the resulting structure to pattern the hard mask layer 28 formed below the mask M into a circular or square shape as shown in FIG. 2B. Referring to FIG. 2C, isotropic etching is performed on the second silicon layer 26 having low concentration formed beneath the hard mask layer 28 shown in FIG. 2B to form a low concentration tip 26a pointed toward the hard mask pattern 28.

The circular or square-shaped hard mask pattern 28 is located on the low concentration tip 26a. FIG. 2D shows the step of doping the second silicon layer 26 with impurities at high concentration using the circular or square-shaped hard mask pattern 28 as a mask. Referring to FIG. 2D, when the second silicon layer 26 is doped with a high concentration of impurities, the impurities are then injected to a predetermined depth from the surface of the second silicon layer 26 to form a high concentration conductive region 26b. Using an isotropic silicon etch mask, i.e., the hard mask pattern 28, as an ion implantation mask will minimize a region undoped at high concentration, compared with the use of a typical photo process. A distance between a distal end of the high concentration conductive region 26b and a front end of the tip is proportional to a resistance within an apparatus for analyzing a semiconductor surface including a semiconductor probe. Thus, as the distance decreases, the sensitivity of measurement on a PN junction between the tip and a sample increases. Thus, the measurement is effective when the PN junction is created between the low concentration region 26a containing only the tip and the semiconductor sample.

Referring to FIG. 2E, after thermal oxidation of the low concentration tip 26a, the oxide layer 24 is wet etched to sharpen the low concentration tip 26a. FIG. 2F shows the step of forming an electrode 27 on one top edge of the high concentration conductive region 26b, which is spaced apart a predetermined distance from the other top edge at which the low concentration tip 26a is formed. The electrode 27 conducts an electric current from an external power supply (not shown) and provides carriers (electrons or holes) to the semiconductor tip 26a through the high concentration conductive region 26b.

FIG. 2G shows the step of performing back-side etching on the first silicon layer 22. Referring to FIG. 2G, an aluminum (Al) layer 29 or a silicon nitride (Si₃N₄) layer is deposited and patterned by a photo process so as to occupy a predetermined area at a position facing the electrode 27. The bulk silicon 22 of the substrate 20 is removed using directional dry or wet etching. During the dry or wet etching, the Al layer 29 or the Si₃N₄ layer serves as a mask.

FIG. 2H shows the step of removing the intermediate oxide layer 24 of the SOI substrate 20 after etching the bulk silicon 22 and completing a semiconductor probe 23 with the semiconductor tip 26a that is in the form of a flexible leaf spring. Thus, the semiconductor probe 23 manufactured according to the present embodiment includes a cantilever containing the high concentration conductive region 26b and the low concentration semiconductor tip 26a formed at one end of the cantilever.

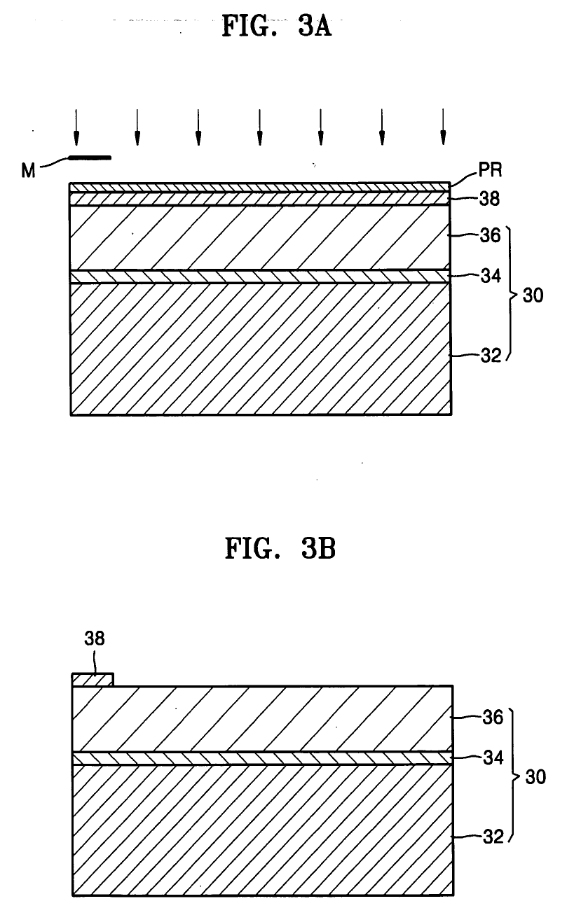

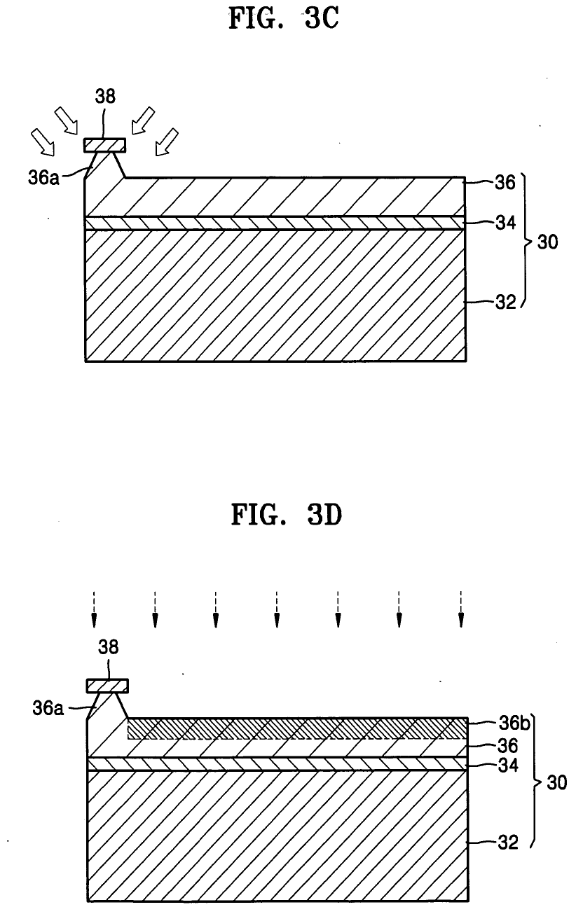

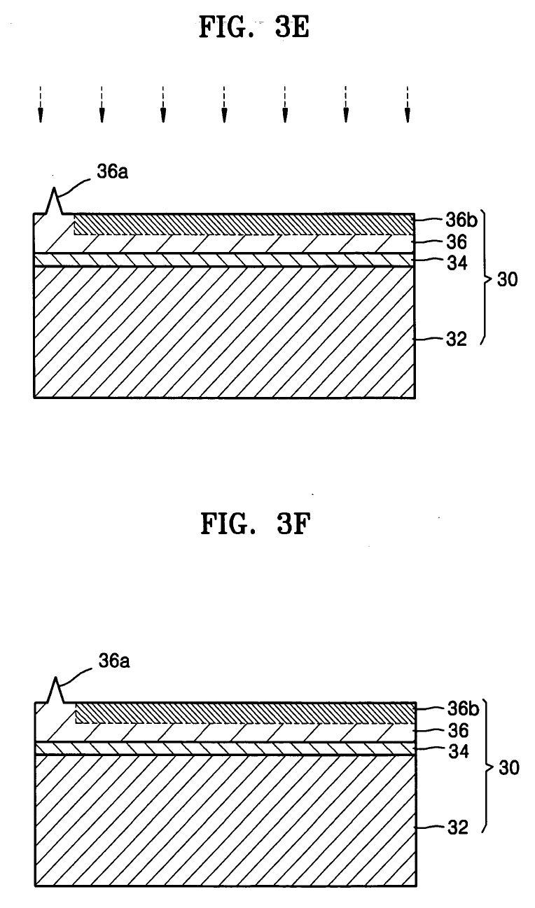

FIGS. 3A-3F illustrate steps of a method of manufacturing a semiconductor probe according to a second embodiment of the present invention. Unlike the manufacturing method of the first embodiment, the method according to the second embodiment allows a semiconductor tip to be doped with impurities over a desired range of concentration.

Referring to FIG. 3A, a hard mask layer 38 is deposited on a SOI substrate 30 consisting of a stack of a first silicon layer 32, an oxide layer 34, and a second silicon layer 36. Subsequently, photoresist PR is deposited on the hard mask layer 38 and a mask M having a predetermined shape is placed above the photoresist PR that is then exposed to light. Then, as shown in FIG. 3B, developing and etching are performed on the photoresist PR to pattern the hard mask layer 38 into the same shape as the mask M. Referring to FIG. 3C, isotropic etching is performed on the second silicon layer 36 underlying the hard mask layer 38 shown in FIG. 3B to form a semiconductor tip 36a having an inclination angle.

Referring to FIG. 3D, when high concentration impurity doping is performed using the hard mask pattern 38 as a mask, the surface of the second silicon layer 36 not blocked by the hard mask pattern 38 is doped with impurities to form a conductive region 36b. The process up to this step is performed in the same manner as for the manufacturing method of the first embodiment.

Referring to FIG. 3E, when low concentration impurity doping is performed after removing the hard mask pattern 38, the semiconductor tip 36a is doped at low concentration and the concentration of the conductive region 36b increases slightly. This step allows more precise adjustment of impurity concentration than in the method according to the first embodiment. However, since the conductive region 36b has been already doped at high concentration, it suffers little variation due to the low concentration doping. Referring to FIG. 3F, after thermal oxidation of the semiconductor tip 36a, the oxide layer 34 is wet etched to sharpen a front end of the semiconductor tip 36a. Subsequent process steps are performed in the same manner as shown in FIGS. 2F-2H.

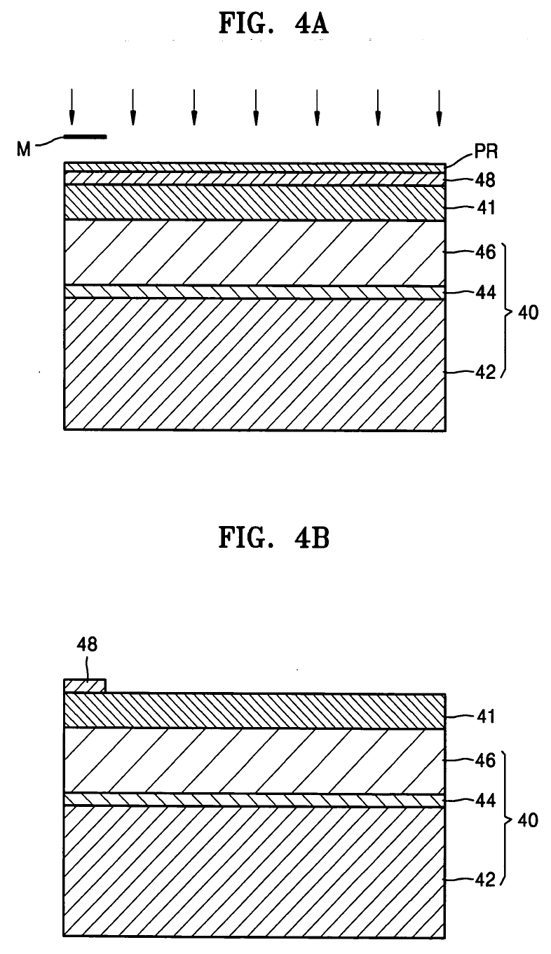

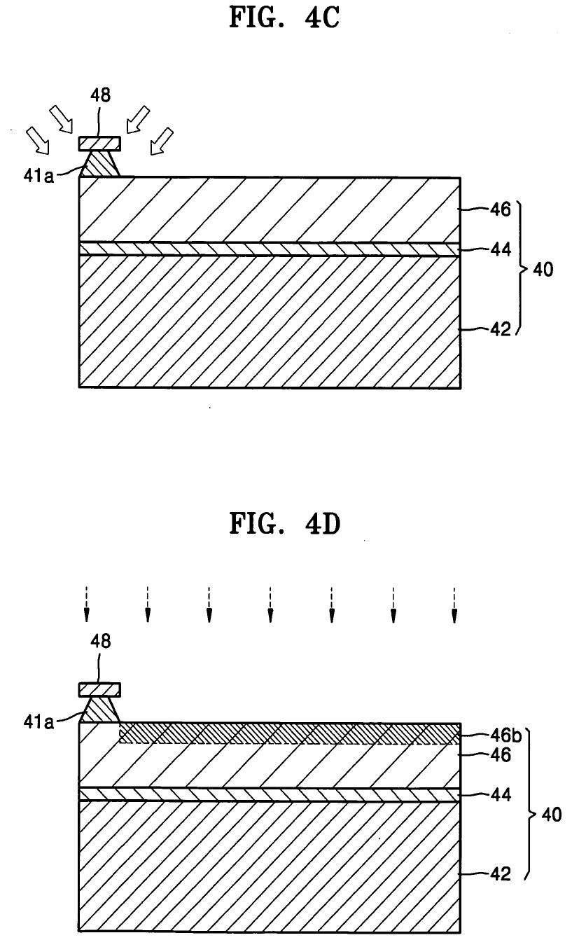

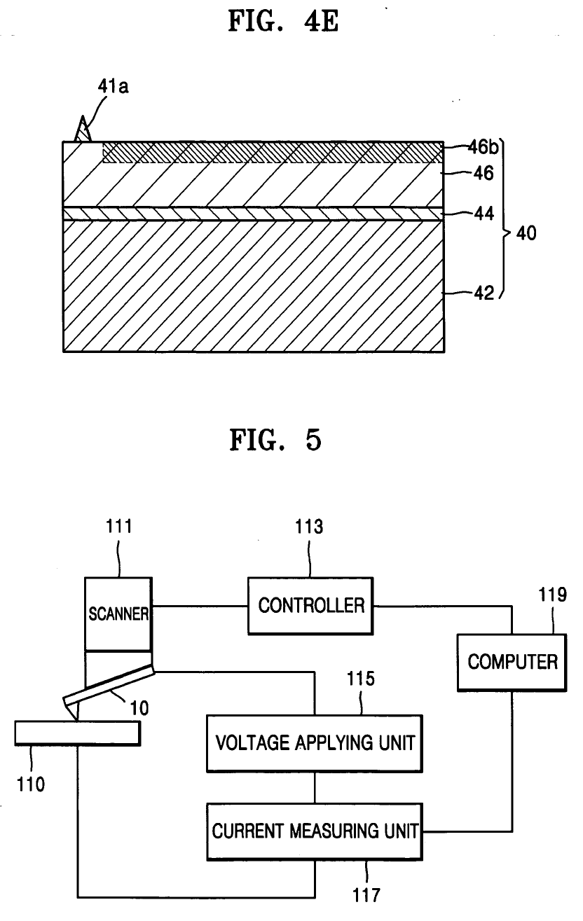

FIGS. 4A-4E illustrate steps of a method of manufacturing a semiconductor probe according to a third embodiment of the present invention. Referring to FIG. 4A, a semiconductor tip layer 41 doped with impurities such as GaAs, diamond-like carbon (DLC), or SiC at a low concentration is formed on a SOI substrate 40. A hard mask layer 48 and a photoresist layer PR are sequentially formed on the semiconductor tip layer 41.

Then, referring to FIGS. 4B and 4C, a photo process is performed to pattern the hard mask layer 48 into a predetermined shape, and isotropic etching is performed on the semiconductor tip layer 41 to form a semiconductor tip 41a. Referring to FIG. 4D, high concentration doping is performed to form a conductive region 46b being in contact with the semiconductor tip 41a. Annealing is performed to sharpen the semiconductor tip 41a as shown in FIG. 4E.

Unlike in the two previous embodiments in which the second silicon layer 26 or 36 is etched to form the semiconductor tip 26a or 36a, the separate semiconductor tip layer 41 is etched to form the semiconductor tip 41a in the present embodiment.

FIG. 5 is a schematic diagram of an apparatus for analyzing a semiconductor surface using a semiconductor probe.

Referring to FIG. 5, the apparatus includes a semiconductor probe 10 that is in contact with the surface of a semiconductor sample 110 and moves with respect to the semiconductor sample 110, a scanner 111 moving the semiconductor probe 10 in both X and Y directions with respect to the surface of the semiconductor sample 110, a controller 113 outputting a signal controlling the movement of the scanner 111, a voltage applying unit 115 applying a predetermined voltage between a tip and the semiconductor sample 110, a current measuring unit 117 measuring the amount of current flowing out of the semiconductor sample 110 through the tip, and a computer 119 receiving a current signal from the current measuring unit 117 for analysis. The computer 119 uses the current signal output from the current measuring unit 117 to detect the impurity concentration of the semiconductor sample 110 and extract an impurity profile across the entire semiconductor surface from the concentration values.

As shown in FIG. 1, the semiconductor probe 10 includes the low concentration tip 11 and the cantilever 15 having the high concentration conductive area 13. The semiconductor probe 10 has opposite polarity to and forms a PN junction with the semiconductor sample 110 to be measured. When an electric field E is applied across both ends of a typical PN junction, electron current density Je and hole electron current density Jh are defined by Equation (1):
Jₑ=−μₙn_{c}E−Dₙ(dn_{c}/dₓ)
Jₕ=−μₚPᵥE−Dₚ(dPᵥ/dₓ) (1)
where μₙ, μₚ, D are constants and dn_{c}/dx and dpᵥ/dx respectively denote variations of concentrations of n- and p-type impurities. Combining both current densities for electrons and holes, the entire current density j is defined by Equation (2):
j=e(Jₕ+Jₑ)(e^{ev/kT}−1) (2)
where k is the Boltzmann constant, T is temperature, and v is an applied voltage.

The current density j is proportional to current I and applied voltage v since the derivative (dj/dV) of the current density j with respect to voltage V is (Jₕ+Jₑ)×(ev/kT). That is, a gradient on a graph of current-voltage (IV) characteristics is proportional to (Jₕ+Jₑ)×(ev/kT). Thus, Jₕ+Jₑ derived from measurement of current and voltage is substituted into the Equation (1) to obtain spatial variations dn_{c}/dx and dpᵥ/dx in impurity concentrations.

When a voltage that swings from negative to positive is applied across both ends of a PN junction, current I flowing through the PN junction is proportional to the impurity concentrations n_{c} and pᵥ in a detection region in contact with the probe. This means density of electrons or holes in a P-type (N-type) semiconductor is derived from a graph of IV characteristics.

For surface analysis of a semiconductor sample, a scanning probe microscope (SPM) is used to form a PN junction between the sample and semiconductor probe. When a predetermined driving voltage is applied between the semiconductor tip and the sample, electrons or holes move through the PN junction between the probe and the sample. As the concentration of impurities in a region of the sample that contacts the semiconductor probe increases, the number of moving carriers and the amount of current detected increase. The concentration of impurity in a local region of the sample is obtained from measuring the amount of current. By scanning the probe over the surface of the sample, an impurity concentration profile of the entire sample is extracted.

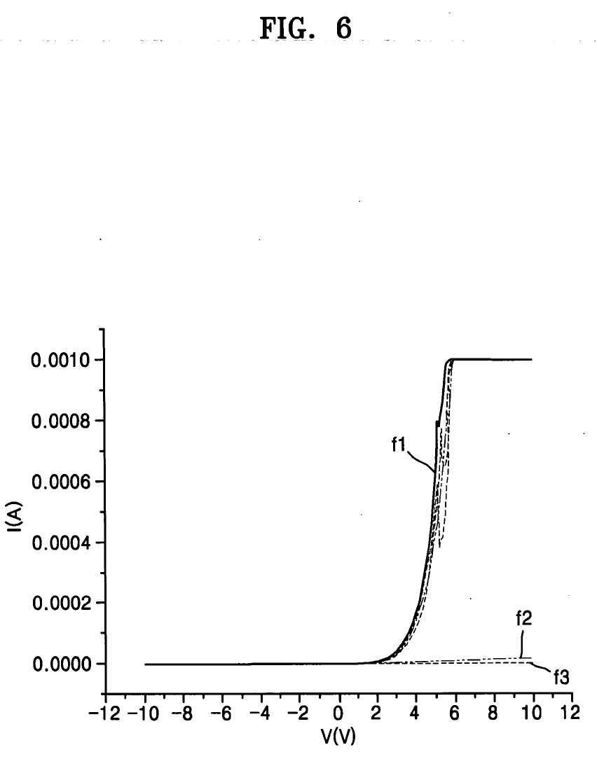

FIG. 6 is a graph illustrating IV characteristics measured on semiconductor samples with different impurity concentrations using a semiconductor probe according to an embodiment of the present invention..

Experiments were conducted to measure p-type semiconductor samples respectively having 1×10²⁰/cm³ concentration of boron, 1×10¹⁶/cm³ concentration of boron, and 5×10¹⁵/cm³ concentration of boron using a semiconductor probe made of an n-type semiconductor containing a 5×10¹⁵/cm³ concentration of phosphorus.

In FIG. 6, f1, f2, and f3 are curves showing changes in IV characteristics measured on the p-type semiconductor samples respectively having 1×10²⁰/cm³ concentration of boron, 1×10¹⁶/cm³ concentration of boron, and 5×10¹⁵/cm³ concentration of boron. As evident from FIG. 6, when current values in graphs f1 and f2 are compared at a specific voltage, e.g., 6 V, there is a large difference between them. Thus, even when different impurity concentration regions are spatially adjacent in one sample, an impurity concentration difference can be extracted.

In the case of Scanning Spreading Resistance Profiling (SSRP), when the amount of current dependent on resistance that varies according to sample concentration distribution, an IV curve has a linear slope. On the other hand, since the IV curves f1, f2, and f3 for the PN junction shown in FIG. 6 represent exponential functions, the analysis method according to the present embodiment is more sensitive to concentration than the SSRP.

The present invention extracts the characteristics of a local PN junction by forming a PN junction between a sample and a tip having a diameter of several to several tens of nanometers (nms). A method for analyzing the concentration of a semiconductor sample using a semiconductor probe according to the present invention has several advantages: non-destructive analysis as opposed to conventional methods, high resolution measurement of spatial concentration using a scanning probe microscopy (SPM) technique, and ease of measurement and quantification as opposed to Scanning Capacitance Microscopy (SCM), and higher sensitivity to concentrations due to the measurement of current based on characteristics of a PN junction than SSRP based on variation in resistance. A method of manufacturing a semiconductor probe according to an embodiment of the present invention provides highly reliable measurements by reducing the resistance between the semiconductor probe and an external voltage applying unit.

The present invention may, however, be embodied in many different forms and should not be construed as being limited to the embodiments set forth herein; rather, these embodiments are provided so that this disclosure will be thorough and complete. For example, it will be obvious to those of ordinary skill in the art to manufacture an apparatus for analyzing a semiconductor surface using one of various shapes of probes including a low concentration tip and a high concentration conductive area without departing from the spirit and scope of the present invention as defined by the following claims.

As described above, a semiconductor probe and an apparatus and method for analyzing a semiconductor surface using the semiconductor probe according to embodiments of the present invention allow precise quantitative extraction of impurity concentrations of a semiconductor sample using high resolution, non-destructive measurement.

A method of manufacturing the semiconductor probe according to the present invention uses a simple process using an isotropic silicon etch mask to fabricate a semiconductor probe including a low concentration tip and a high concentration conductive area with low manufacturing costs.

What is claimed is:

1. A semiconductor probe comprising:
a semiconductor tip containing a low concentration of impurities; and
a cantilever having a conductive area formed in close proximity to the semiconductor tip attached at one end thereof and doped with a high concentration of impurities.

2. The probe of claim 1, further comprising an electrode that is formed on the cantilever and conducts an electric current between the conductive area and an external power supply.

3. The probe of claim 1, wherein the semiconductor tip has an impurity concentration of 10¹⁵/cm³ to 10²⁰/cm³.

4. The probe of claim 3, wherein the impurities are one of arsenic (As), phosphorous (P), and boron (B).

5. The probe of claim 1, wherein the semiconductor tip comprises silicon, gallium arsenide (GaAs), diamond-like carbon (DLC), or silicon carbide (SiC).

6. A method of manufacturing a semiconductor probe, comprising:
forming a hard mask layer on a substrate doped at a low concentration and patterning the hard mask layer into a predetermined shape at a region where a semiconductor tip will be formed;
etching the substrate underlying the hard mask layer and forming the semiconductor tip;
doping a portion of the substrate not blocked by the hard mask layer with high concentration impurities and forming a conductive area; and
removing the hard mask layer and sharpening the semiconductor tip.

7. The method of claim 6, wherein the semiconductor tip has an impurity concentration of 10¹⁵/cm³ to 10²⁰/cm³.

8. The method of claim 6, wherein the impurities are one of arsenic (As), phosphorous (P), and boron (B).

9. The method of claim 6, wherein the substrate comprises silicon.

10. The method of claim 6, wherein the semiconductor tip comprises gallium arsenide (GaAs), diamond-like carbon (DLC), or silicon carbide (SiC).

11. The method of claim 6, wherein the hard mask layer is an oxide layer formed by thermal oxidation.

12. A method of manufacturing a semiconductor probe, comprising:
forming a hard mask layer on a substrate and patterning the hard mask layer into a predetermined shape at a region where a semiconductor tip will be formed;
etching the substrate underlying the hard mask layer and forming the semiconductor tip;
doping a portion of the substrate not blocked by the hard mask layer with high concentration impurities and forming a conductive area; and
removing the hard mask layer, doping the semiconductor tip with a low concentration of impurities, and sharpening the semiconductor tip.

13. The method of claim 12, wherein the semiconductor tip has an impurity concentration of 10¹⁵/cm³ to 10²⁰/cm³.

14. The method of claim 12, wherein the impurities are one of arsenic (As), phosphorous (P), and boron (B).

15. The method of claim 12, wherein the substrate comprises silicon.

16. The method of claim 12, wherein the semiconductor tip comprises gallium arsenide (GaAs), diamond-like carbon (DLC), or silicon carbide (SiC).

17. The method of claim 12, wherein the hard mask layer is an oxide layer formed by thermal oxidation.

18. A method of manufacturing a semiconductor probe, comprising:
depositing a semiconductor tip layer doped with impurities at a low concentration on a substrate;
forming a hard mask layer on the semiconductor tip layer and patterning the hard mask layer into a predetermined shape at a region where a semiconductor tip will be formed;
etching the semiconductor tip layer underlying the hard mask layer and forming the semiconductor tip;
doping a portion of the substrate not blocked by the hard mask layer with high concentration impurities and forming a conductive area; and
removing the hard mask layer and sharpening the semiconductor tip.

19. The method of claim 18, wherein the semiconductor tip has an impurity concentration of 10¹⁵/cm³ to 10²⁰/cm³.

20. The method of claim 18, wherein the impurities are one of arsenic (As), phosphorous (P), and boron (B).

21. The method of claim 18, wherein the substrate comprises silicon.

22. The method of claim 18, wherein the semiconductor tip layer comprises gallium arsenide (GaAs), diamond-like carbon (DLC), or silicon carbide (SiC).

23. The method of claim 18, wherein the hard mask layer is an oxide layer formed by thermal oxidation.

24. An apparatus for analyzing a surface of a semiconductor sample, the apparatus comprising:
a semiconductor probe including a tip containing a low concentration of impurities and a cantilever with a conductive area doped with a high concentration of impurities, the semiconductor probe contacting and forming a PN junction with the surface of the semiconductor sample;
a scanner moving the semiconductor probe with respect to the surface of the semiconductor sample; and
a controller outputting a signal driving the scanner detecting an impurity concentration in a region on the surface of the semiconductor sample that contacts the semiconductor probe by measuring current flowing into the semiconductor sample after application to the semiconductor probe.

25. The apparatus of claim 24, wherein the sample comprises silicon (Si), gallium arsenide (GaAs), diamond-like carbon (DLC), or silicon carbide (SiC).

26. The apparatus of claim 24, wherein the tip has an impurity concentration of 10¹⁵/cm³ to 10²⁰/cm³.

27. The apparatus of claim 24, wherein the impurities are one of arsenic (As), phosphorous (P), and boron (B).

28. The apparatus of claim 24, wherein the tip comprises Si, GaAs, DLC, or SiC.

29. A method for analyzing a surface of a semiconductor sample using the semiconductor sample and a semiconductor probe in contact with the semiconductor sample, the-method comprising:
forming a PN junction between the semiconductor sample and the semiconductor probe having a tip having opposite polarity to the semiconductor sample; and
detecting impurity concentration of the semiconductor sample from variation in current flowing through the semiconductor probe.

30. The method of claim 29, wherein the sample comprises silicon (Si), gallium arsenide (GaAs), or silicon carbide (SiC).

31. The method of claim 29, wherein the semiconductor probe includes a cantilever with a conductive area doped with a high concentration of impurities and the tip attached at one end of the cantilever.

32. The method of claim 29, wherein the tip has an impurity concentration of 10¹⁵/cm³ to 10²⁰/cm³.

33. The method of claim 29, wherein the impurities are one of arsenic (As), phosphorous (P), and boron (B).

34. The method of claim 29, wherein the tip comprises silicon (Si), gallium arsenide (GaAs), diamond-like carbon (DLC), or silicon carbide (SiC).
